(19) United States
(12) Patent Application Publication
(10) Pub. No.: US 2007/0168889 A1
(43) Pub. Date: Jul. 19, 2007

(54) Method, system, and program product for indicating a state of a value of a property of an application

(75) Inventors: Casey Best, Sidney (CA); Brad Debroni, Victoria (CA); Eric Dunn, Victoria (CA); Michael Erickson, Victoria (CA); Bryan Gilbert, Victoria (CA); Gary V. Jipp, Victoria (CA); Michael Mansell, Victoria (CA); John C. Phillips, Victoria (CA)

Correspondence Address: HOFFMAN WARNICK & DALESSANDRO LLC, 75 STATE ST, 14TH FLOOR, ALBANY, NY, 12207, US

(73) Assignee: INTERNATIONAL BUSINESS MACHINES CORPORATION, ARMONK, NY (US)

(21) Appl. No.: 11/335,278

(22) Filed: Jan. 19, 2006

(51) Int. Cl. G06F 3/048

(52) U.S. Cl. 715/859

(57) ABSTRACT

The present invention provides a method, system, and program product for indicating a state of a value of an application. Specifically, under the present invention a graphical state indicator is displayed for a property (e.g., background screen color) of an application. The graphical state indicator will indicate a “state” of a value of the property. That is, the graphical state indicator will indicate whether the value is a user-defined value, or is a default value. Under the present invention, a graphical state indicator can be provided for any property of the application. As such, multiple graphical state indicators may be simultaneously displayed. The present invention can also display a graphical value indicator for indicating the current value (e.g., blue) of the property (e.g., background screen color). This value can be changed based upon an interaction with the graphical value indicator by a user.

### BACKGROUND OF THE INVENTION

1. Field of the Invention

In general, the present invention relates to indicating a state of a value of a property of an application. Specifically, the present invention relates to a method, system, and program product for indicating a state of a value of an application (i.e., a computer application).

2. Related Art

Many computer applications (e.g., website designer applications, house blueprint designer applications, etc.) use the following paradigm: (1) generic items exist within a canvas; (2) properties on each item can be set to customize the item; and (3) each property has some value. As known, the value(s) might be set by the user, or may be the result of a calculation within the application (which also includes an empty value). The former is defined as a user-defined value, while the latter is defined as a default value.

Many applications show the value of a property in some form, but fail to show/indicate whether a user set the value, or if the value is a default value. Along these lines, if the user sets the value of the property to be the same as the defaulting value, the user will not have any obvious way of distinguishing the two, yet the system may treat them very differently. For example, in a forms designer application, a page has a background color. If the user does not set an explicit color, the color is derived from the background color for the form (i.e., the default value for the color property on the page). When the user changes the form's background color, the page's color will also change. However, if the user sets the page's color his/herself, the page's color will not change when the form's background color changes. Without a mechanism to indicate when the property will change, the user may be unpleasantly surprised when their page changes or fails to change color. This notion can apply to other properties of the application (e.g., font size, font type, etc.).

It is also important to be able to switch quickly between the two states (default and user-defined). In the above example, the user may wish the color of the page to be the same as the form, but he/she may not want the color of the page to change if someone changes the form's color. As such, the user should have a simple way of forcing the value of the property to be the value of the current default value. The opposite is also true. If the user sets the value of a property, the user should be able to reset the property to use the default value instead.

In view of foregoing, there exists a need in the art to overcome at least one of deficiencies in the related art.

### SUMMARY OF THE INVENTION

In general, the present invention relates to a method, system, and program product for indicating a state of a value of an application (i.e., a computer application). Specifically, under the present invention a graphical state indicator is displayed for a property (e.g., background screen color) of an application (e.g., on an electronic page provided by the application). The graphical state indicator will indicate a “state” of a value of the property. That is, the graphical state indicator will indicate whether the current value of the property is a user-defined value, or is a default value. Under the present invention, a graphical state indicator can be provided for any property of the application. As such, multiple graphical state indicators may be simultaneously displayed. The present invention can also display a graphical value indicator on the electronic page for indicating and/or changing the actual value (e.g., blue) of the property (e.g., background screen color). That is, the value can be changed based upon an interaction with the graphical value indicator (e.g., by a user).

One aspect of the present invention provides a method for indicating a state of a value of a property of an application, comprising: displaying a graphical state indicator for the property; and indicating whether a value of the property is a default value using the graphical state indicator.

Another aspect of the present invention provides a system for indicating a state of a value of a property of an application, comprising: means for displaying a graphical state indicator for the property; and means for indicating whether a value of the property is a default value using the graphical state indicator.

Another aspect of the present invention provides a program product stored on a computer readable medium for indicating a state of a value of a property of an application, the computer readable medium comprising program code for causing a computer system to perform the following steps: displaying a graphical state indicator for the property; and indicating whether a value of the property is a default value using the graphical state indicator.

Another aspect of the present invention provides a method for indicating a state of a value of a property of an application, comprising: providing a computer infrastructure being operable to: display a graphical state indicator for the property; and indicate whether a value of the property is a default value using the graphical state indicator.

Another aspect of the present invention provides a method for indicating a state of a value of a property of an application, comprising: displaying a graphical state indicator for the property on an electronic page provided by the application; indicating whether a value of the property is a default value using the graphical state indicator; displaying a graphical value indicator proximate the graphical state indicator on the electronic page; indicating the value using the graphical value indicator; and changing the value based upon an interaction with the graphical value indicator.

In another aspect of the present invention, the graphical state indicator indicates whether the value of the property is a user-defined value.

In another aspect of the present invention, a value system will display a graphical value indicator for indicating the value.

In another aspect of the present invention, the graphical value indicator is displayed proximate the graphical state indicator.

In another aspect of the present invention, the value is changed based on an interaction with the graphical value indicator.

Therefore, the present invention relates to a (computer-implemented) method, system, and program product for indicating a state of a value of an application (i.e., a computer application).

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts a system for indicating a state of a value of a property of an application according to the present invention.

FIG. 2 depicts possible combinations of values and states of a property according to the present invention.

FIG. 3 depicts a screen shot showing a graphical state indicator in a first state and a graphical value indicator in a first setting, according to the present invention.

FIG. 4 depicts a screen shot showing the graphical state indicator of FIG. 3in a second state and the graphical value indicator in the first setting, according to the present invention.

FIG. 5 depicts a screen shot showing the graphical state indicator of FIG. 3 in the second state and the graphical value indicator in a second setting, according to the present invention.

FIG. 6 depicts a screen shot showing the changing of a value based upon an interaction with the graphical value indicator, according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE DRAWINGS

As indicated above, the present invention relates to a method, system, and program product for indicating a state of a value of an application (i.e., a computer application). Specifically, under the present invention a graphical state indicator is displayed for a property (e.g., background screen color) of an application (e.g., on an electronic page provided by the application). The graphical state indicator will indicate a “state” of a value of the property. That is, the graphical state indicator will indicate whether the current value of the property is a user-defined value, or is a default value. Under the present invention, a graphical state indicator can be provided for any property of the application. As such, multiple graphical state indicators may be simultaneously displayed. The present invention can also display a graphical value indicator on the electronic page for indicating and/or changing the actual value (e.g., blue) of the property (e.g., background screen color). That is, the value can be changed based upon an interaction with the graphical value indicator (e.g., by a user).

Thus the present invention, among other things, can let a user: (1) know what the value is, regardless of whether or not it is a default value; (2) know whether the value is a default value or is a user-defined value; and (3) visibly toggle the value of the property. As used herein, the phrase “state of a value” is intended to refer to whether the value is a user-defined value or is a default value.

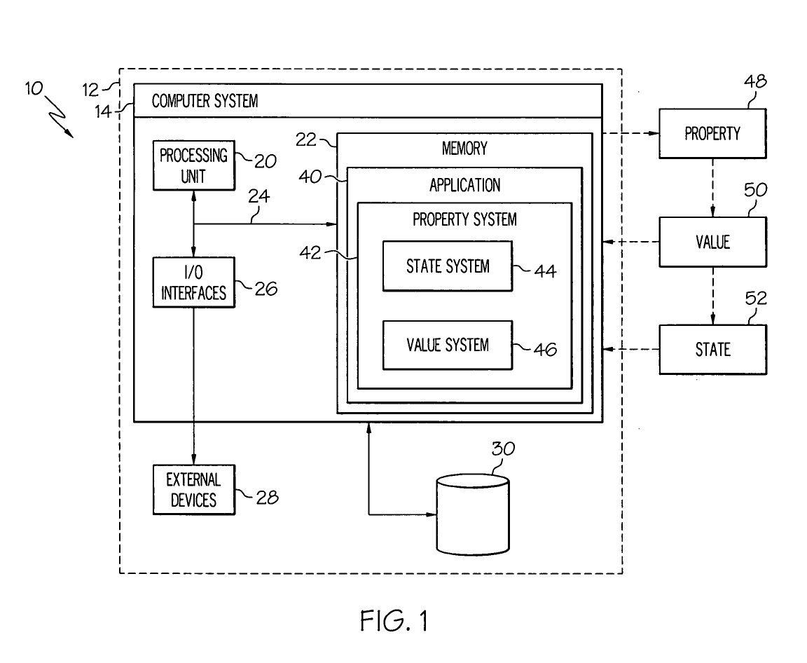

Referring now to FIG. 1, a system 10 for indicating a state of a value of an application according to the present invention is shown. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to indicate states of values of properties of applications.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code such as application 40 and/or property system 42, which are stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28.

Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such a property values, states of values, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is property system 42, which is shown implemented within application 40. It should be understood that property system 42 need not be implemented within the confines of application 40. That is, the two could be implemented separately, but work in conjunction with one another. Along these lines, property system 42 could be implemented, for example, as a plug-in to application 40.

In any event, as will be further described below, property system 42 will provide at least one graphical indicator that will be displayed (e.g., on a graphical user interface) to indicate a state 52 of a value 50 of a property 48 of application 40 and/or change value 50 of property 48. As indicated above, previous approaches have not allowed a user to easily (e.g., visually) see whether value 50 of property 48 is a user-defined value, or is a default value. For example, if a user operates application, and is presented with a screen having a certain background color (e.g., blue), there is currently no direct way for the user to know whether the background color is the default background color, or was manually set to blue by his/herself or another user. The present invention addresses this and other issues.

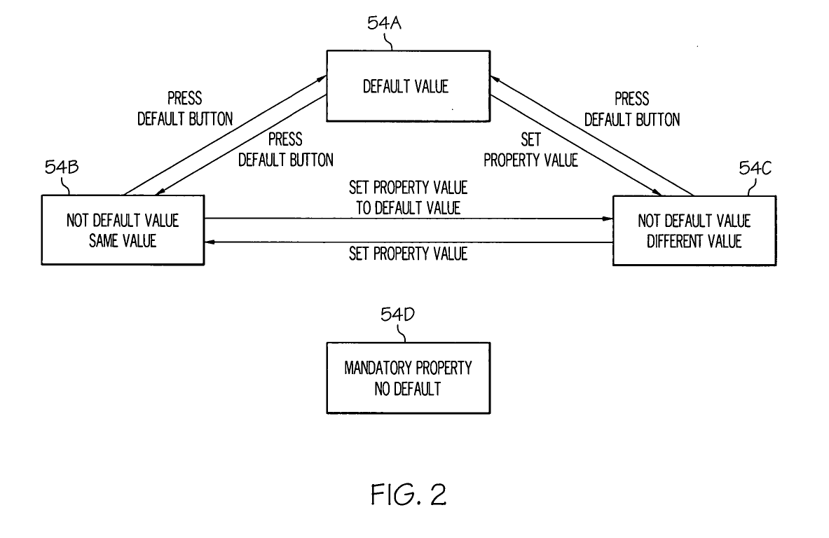

Referring to FIG. 2, the possible combinations 54A-D of state 52 (FIG. 1) and value 50 (FIG. 1) for property 48 (FIG. 1) according to the present invention are shown. As depicted, in state-value combination 54A, property 48 is set to a default value. In state-value combination 54B, property 48 (FIG. 1) is not set to a default value (i.e., is set to a user-defined value), but is set to a value that is the same as the default value. In state-value combination 54C, property 48 (FIG. 1) is not a default value (i.e., is a user-defined value), and has a different value than the default value. In state-value combination 54D, property 48 is a mandatory property, meaning that that it has no default value and is set to a user-defined value.

As will be further described below, the present invention provides (among other things) a graphical state indicator and a graphical value indicator. One or both of these indicators can be toggled or otherwise interacted with by a user. For example, toggling of the graphical value indicator provides movement between combinations 54A-C as follows:

State-Value Combination 54A: The user can interact with (e.g., graphically select/press) the graphical value indicator to move to state-value combination 54B, or set the property's value to move to state-value combination 54C.

State-Value Combination 54B: The user can interact with the graphical value indicator to move to state-value combination 54A, or set the property's value to move to state-value combination 54C.

State-Value Combination 54C: The user can interact with the graphical value indicator to move to state-value combination 54A, or set the property's value to the same value as the default value to move to state-value combination 54B.

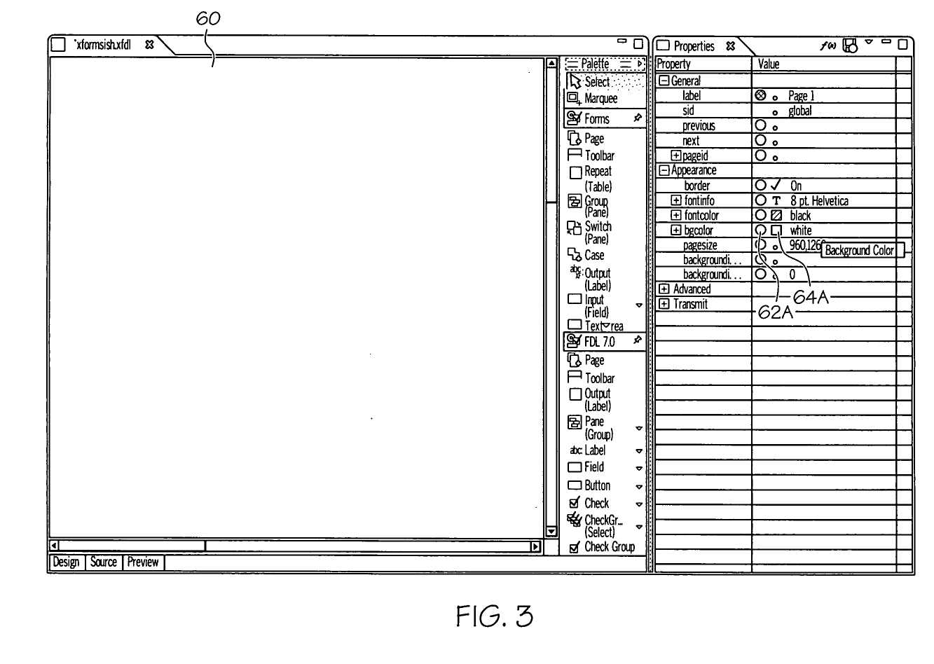

Referring back to FIG. 1, property system 42 is shown including state system 44 and value system 46. These sub-systems will be described in conjunction with FIGS. 3-5. It should be understood in advance that although the teachings of the present invention will be described in conjunction with the property of “background screen color” of a graphical editor application, they could be implemented in conjunction with any property (e.g., font size, font type, etc.) of any application.

In any event, under the present invention, state system 44 will generate and display a graphical state indicator for at least one property 48 of application 40. Referring to FIG. 3, an illustrative graphical state indicator 62A is shown as displayed on electronic page 60. In general, FIG. 3 depicts combination 54A (FIG. 2) of state and value. Based on whether a current value of a corresponding property (e.g., background screen color) is set to a default value or a user-defined value, state system 44 (FIG. 1) will make graphical state indicator 62A have a certain visual appearance. This allows a user to quickly determine the state of the value of the property. In the example shown in FIG. 3, graphical state indicator 62A comprises a “button” that will appear blank if the background screen color is set to a default value. It should be understood, however, that this could be reversed. That is, graphical state indicator 62A could be blank for a property that is set to a user-defined value.

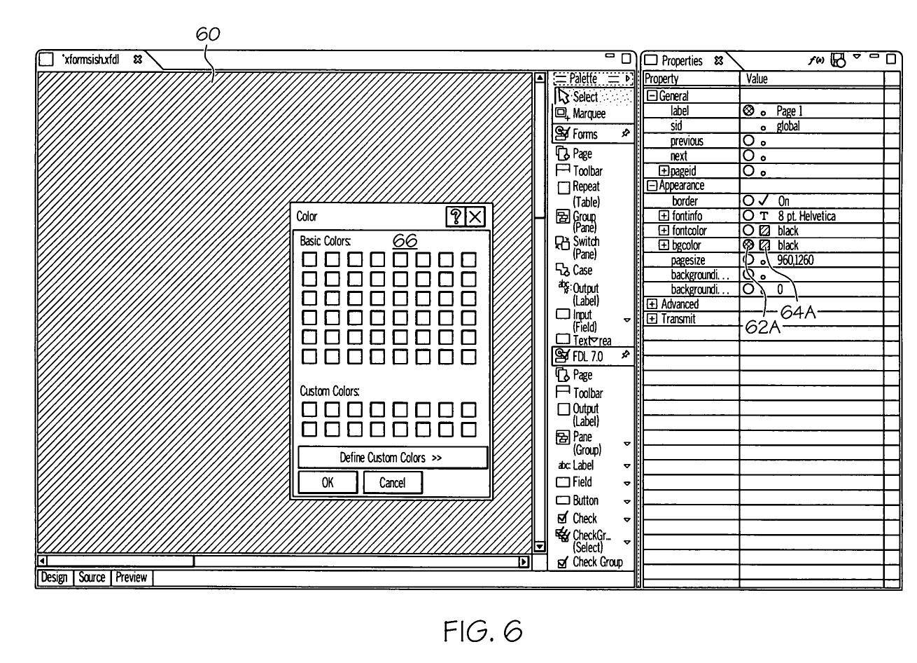

Also shown in FIG. 3 is a graphical value indicator 64A, which can be generated and displayed by value system 46 (FIG. 1) on electronic page 60. In general, graphical value indicator 64A indicates the value of the property. For example, the background screen color is white, as indicated by the white color of graphical value indicator 64A. This functionality is provided by value system 46. Further, the value of the property can be changed based upon an interaction with graphical value indicator 64A by the user. For example, as shown in FIG. 6, a value dialog 66 is shown as displayed on electronic page 60. Value dialog 66 can be displayed (e.g., by value system 46), for example, when a user “clicks on” or otherwise interacts with graphical value indicator graphical 64A. When a new value (e.g., a color) is selected from value dialog 66, the value of the property to which graphical value indicator 64A corresponds will be changed to the new value. Similarly, graphical value indicator 64A will be changed to the new value (e.g., the new color) by value system 46.

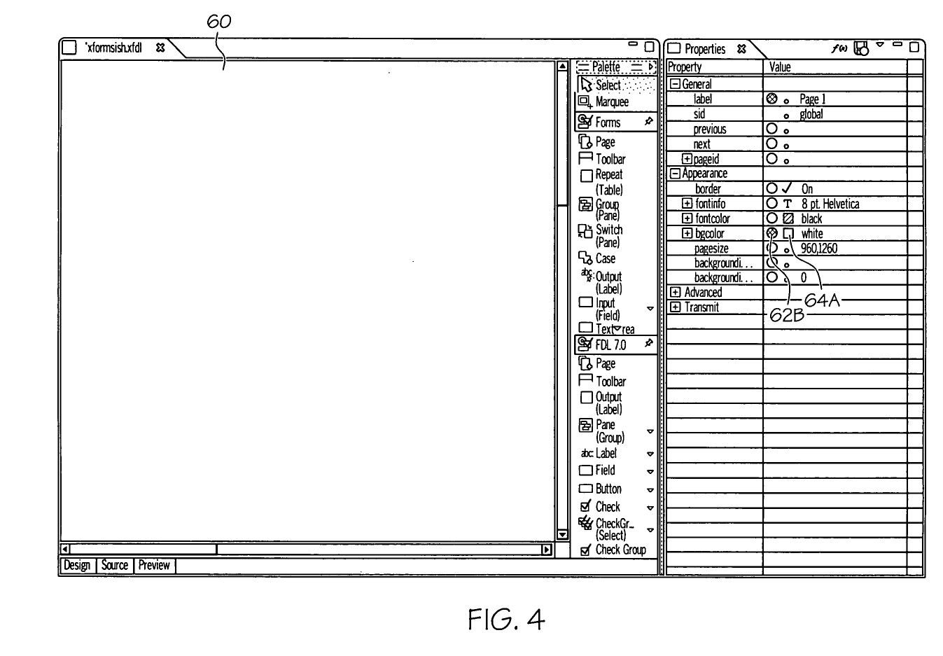

Referring to FIG. 4, state-value combination 54B (FIG. 2) will be described. Specifically, as can be seen, graphical value indicator 62B has been toggled or at least is different in appearance from graphical value indicator 62A of FIG. 3. This change was made by state system 44 (FIG. 1) in response to the value of the background screen color property being set by the user (i.e., being set to a user-defined value). In this scenario, the value of the background screen color was set by the user, but was set to a value that is the same as the default value (e.g., white). As such, while state system 44 will change the appearance of graphical state indicator 62B, because the actual value has not changed, graphical value indicator 64A will be kept the same in appearance by value system 46 (FIG. 1).

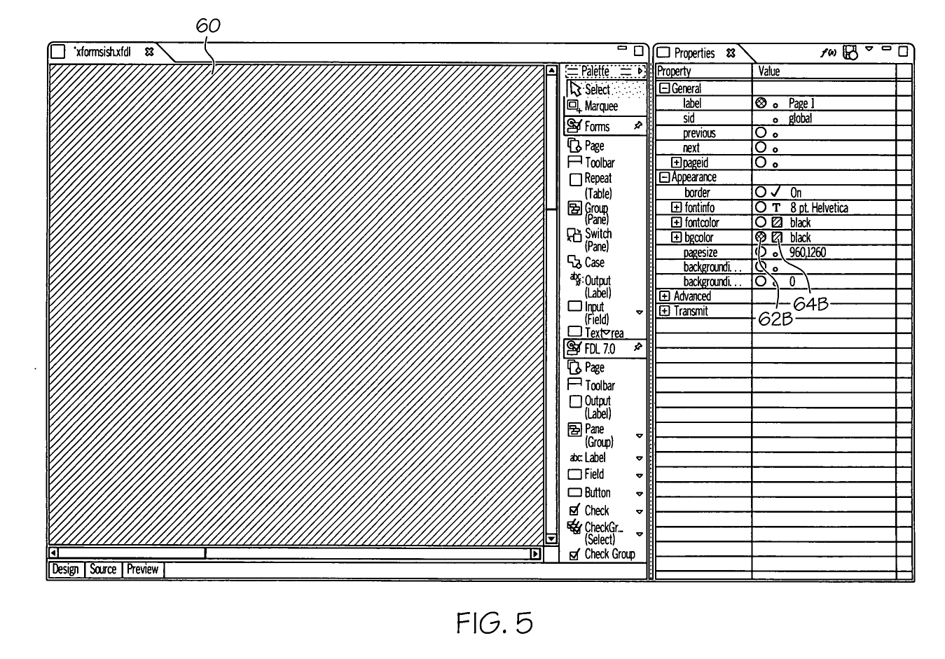

Referring to FIG. 5, state-value combination 54C (FIG. 2) will be described. Specifically, as can be seen, graphical value indicator 62B has been toggled by state system 44 (FIG. 1) similar to FIG. 4, which indicates that the value for background screen color has been set by the user (i.e., is user-defined). However, in this instance, the appearance of graphical value indicator 64B has been changed by value system 46 (FIG. 1). This illustrates that the background screen color has now been set to a new value (e.g., black) that is different from the old value (e.g., white). For color-based properties, graphical value indicator 64B will typically be given the color of the current setting. As such, if the user sets the background screen color to black, then graphical value indicator 64B will be colored black by value system 66.

It should be understood that the type/form of graphical indicators 62A-B and 64A-B can be varied within the scope of the present invention. That is, graphical indicators 62A-B and 64A-B do not have to be a button and/or box, respectively. To this extent, state system 44 (FIG. 1) and value system 46 (FIG. 1) could generate and display any type/form of graphical indicators that would visually alert the user to the state and/or value of a property. For example, graphical value indicator 64A-B could be a “check” mark, a font symbol, a font size, etc. Moreover, although referred to as two separate graphical indicators 62A-B and 64A-B, the state graphical indicator 62A-B and graphical value indicator 64A-B could be embodied as a single graphical indicator. In such a case, the single graphical indicator (not shown) would not only indicate a state of a value of a property, but could also be toggled/interacted with to change the current value. Along these lines, although graphical state indicator 62A-B and graphical value indicator 64A-B are shown as separate elements, they could be considered a single mechanism by which state and value can be indicated and changed.

While shown and described herein as a method and system for indicating and/or changing a state of a value of a property of an application, it is understood that the invention further provides various alternative embodiments. For example, in one embodiment, the invention provides a computer-readable/useable medium that includes computer program code to enable a computer infrastructure to indicate and/or change a state of a value of a property of an application. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to indicate and/or change a state of a value of a property of an application. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for indicating a state of a value of a property of an application. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for indicating a state of a value of a property of an application, comprising:
displaying a graphical state indicator for the property; and
indicating whether a value of the property is a default value using the graphical indicator.

2. The method of claim 1, further comprising indicating whether the value of the property is a user-defined value using the graphical indicator.

3. The method of claim 1, further comprising displaying a graphical value indicator for indicating the value.

4. The method of claim 3, wherein the graphical value indicator is displayed proximate the graphical state indicator.

5. The method of claim 3, further comprising changing the value based on an interaction with the graphical value indicator.

6. A system for indicating a state of a value of a property of an application, comprising:
means for displaying a graphical state indicator for the property; and
means for indicating whether a value of the property is a default value using the graphical indicator.

7. The system of claim 6, further comprising means for indicating whether the value of the property is a user-defined value using the graphical indicator.

8. The system of claim 6, further comprising means for displaying a graphical value indicator for indicating the value.

9. The system of claim 8, wherein the graphical value indicator is displayed proximate the graphical state indicator.

10. The system of claim 8, wherein the value is changed based on an interaction with the graphical value indicator.

11. A program product stored on a computer readable medium for indicating a state of a value of a property of an application, computer readable medium comprising program code for causing a computer system to perform the following steps:
displaying a graphical state indicator for the property; and
indicating whether a value of the property is a default value using the graphical indicator.

12. The method of claim 11, the computer readable medium further comprising program code for causing the computer system to perform the following step: indicating whether the value of the property is a user-defined value using the graphical indicator.

13. The method of claim 11, the computer readable medium further comprising program code for causing the computer system to perform the following step: further comprising displaying a graphical value indicator for indicating the value.

14. The method of claim 13, wherein the graphical value indicator is displayed proximate the graphical state indicator.

15. The method of claim 13, the computer readable medium further comprising program code for causing the computer system to perform the following step: changing the value based on an interaction with the graphical value indicator.

16. A method for indicating a state of a value of a property of an application, computer readable medium comprising:
providing a computer infrastructure being operable to:
display a graphical state indicator for the property; and
indicate whether a value of the property is a default value using the graphical indicator.

17. The method of claim 16, the computer infrastructure being further operable to indicate whether the value of the property is a user-defined value using the graphical indicator.

18. The method of claim 16, the computer infrastructure being further operable to display a graphical value indicator proximate the graphical state indicator for indicating the value.

19. The method of claim 18, the computer infrastructure being further operable to change the value based on an interaction with the graphical value indicator.

20. A method for indicating a state of a value of a property of an application, comprising:
displaying a graphical state indicator for the property on an electronic page provided by the application;
indicating whether a value of the property is a default value using the graphical state indicator;
displaying a graphical value indicator proximate the graphical state indicator on the electronic page;
indicating the value using the graphical value indicator; and
changing the value based upon an interaction with the graphical value indicator.
